(19) United States
(12) Patent Application Publication
(10) Pub. No.: US 2010/0102044 A1
(43) Pub. Date: Apr. 29, 2010

(54) FILM CUTTING APPARATUS AND FILM CUTTING METHOD

(76) Inventors: Yoji Takizawa, Kanagawa (JP); Hachiya Takeuchi, Kanagawa (JP); Shinichi Tezuka, Kanagawa (JP); Hisashi Nishigaki, Kanagawa (JP)

Correspondence Address: SNELL & WILMER LLP (OC), 600 ANTON BOULEVARD, SUITE 1400, COSTA MESA, CA, 92626, US

(21) Appl. No.: 12/443,173

(22) PCT Filed: Sep. 19, 2007
(86) PCT No.: PCT/JP2007/001013

§ 371 Date: Jul. 9, 2009

(30) Foreign Application Priority Data
Sep. 27, 2006 (JP) 2006-261836

(51) Int. Cl. B23K 26/00

(52) U.S. Cl. 219/121.72; 219/121.67

(57) ABSTRACT

A film cutting device and a film cutting method, in which smoke produced while a protective film is being cut by a laser along the outer and inner edges of a substrate can be prevented from adhering to the film and be efficiently exhausted, are provided. The device has a laser radiation device 6 for cutting a film 1 along the outer and inner edges of a disk by laser radiation, a first air intake unit 3 and a second air intake unit 4 for suctioning the smoke that is produced while the film is cut by laser radiation, and an adjusting unit 5 for adjusting air flow of the first air intake unit 3 to control the flow of smoke onto the surface of the film 1 corresponding to the disk. An incision is formed on the inside of the inner edge by the laser radiation device 6 before the film 1 is cut along the inner edge.

### TECHNICAL FIELD

The present invention relates to a film cutting device and a film cutting method in which a film that is applied to protect the surface of an optical disk, or the like, is cut along the inner and outer edges of the optical disk.

### BACKGROUND ART

Optically read disk-shaped recording media such as optical disks and magnetic optical disks require the formation of a layer of resin as a protective layer to protect the recording surface that has been formed on a substrate. When a single layer is used in Blu-ray disks (BD), for example, a polycarbonate substrate is produced through injection molding, a reflective film or the like is formed by sputtering or the like, and a resin film sheet is then applied or resin is applied through spin-coating to form the protective layer.

When a film sheet is applied in this case, it is necessary to cut the film along the shape of the disk in order to prepare a disk-shaped sheet. Such film cutting has conventionally been accomplished with blades, mold punching, or the like. However, cutting methods which involve mechanical contact such as this can result in burrs and chips at the cut corners. In addition, blades and molds gradually deteriorate as a result of continued use, resulting in product variability over the period of time from initial use until the end of the use life.

Such burrs, chips, and product variability result in a higher probability of errors during signal characteristic tests as well as lower yields in the case of high density disks which require the formation of a 0.1 mm thick cover layer on a 1.1 mm thick disk, such as Blu-ray disks.

Methods for non-contact cutting instead of cutting through mechanical contact such as with blades or dies may be contemplated in order to address such problems. Laser methods, for example, are known to produce a smoothly finished cut. However, smoke is produced where the cuts are made by lasers, and this smoke can adhere to the sheet, causing contamination. In the laser machining techniques disclosed in Patent Documents 1 and 2, cuts are therefore ventilated to prevent smoke residue.
Patent Document 1: Japanese Patent Application Laid-open No. H6-285668
Patent Document 2: Published Japanese Translation of PCT application No. 2002-537140

However, the use of the above conventional laser machining techniques suffers from the following problems when used for protective films on disks. Specifically, when smoke is merely suctioned off through a suctioning device located in a fixed position, the smoke may pass through the surface of the film, due to the direction of the air flow produced by the device, resulting in smoke adhesion.

Particularly when a round shape on the inside is cut out along the inner edge of the disk, suctioning from the outside may, due to the air flow from the inside to the outside, result in smoke passing through the surface of the film, leading to smoke adhesion. However, when smoke is suctioned off from above the inner edge, the film tends to float, and when suctioned from below the inner edge, the gap produced at the start of cutting is too small, thus making it difficult for the smoke to be efficiently exhausted downward from that area.

### DISCLOSURE OF THE INVENTION

An object of the present invention, which is intended to overcome the problems of the conventional technology described above, is to provide a film cutting device and film cutting method in which smoke that is produced while a protective film is being cut by a laser along the outer and inner edges of a substrate can be efficiently exhausted while the smoke is prevented from adhering to the film.

To achieve the above object, the film cutting device of the present invention is characterized by having: a cutting unit for cutting film along outer and inner edges of a substrate by laser radiation; a suction unit for suctioning smoke produced when the film is cut by the cutting unit; and an adjusting unit for adjusting an air flow of the suction device to control the flow of smoke onto the film surface that corresponds to the substrate.

In the invention as described above, film can be cut by a laser as the flow of smoke onto the surface corresponding to the substrate is controlled, thus making it possible to prevent smoke adhesion and the creation of burrs and chips.

Another aspect of the invention is characterized in by further having an incision unit for forming an incision on the inside of the inner edge before or when the film, which is aligned along the inner edge, is cut by the cutting device.

A film cutting method in another aspect of the invention is characterized by including: cutting a film along the outer edge of a substrate by laser radiation, and allowing smoke produced during the cutting to be suctioned off in the outward direction toward the outer edge of the substrate in the film past; forming an incision in the film on the inside of the inner edge of the substrate using laser radiation or a cutter; and cutting the film along the inner edge of the substrate and allowing the smoke, produced during the film cutting, to be suctioned off in the direction toward the inner edge of the substrate in the film.

In the aspect described above, an incision is made on the inside when the inner edge is being cut, thus allowing smoke to be efficiently exhausted even when suctioned from below.

Another aspect is characterized in that the cutting unit and the incision unit serve as a laser radiation device.

In the above aspect, the outer and inner edge cutting and incision can all be accomplished with a single laser radiation device, thus making it possible to simplify the structure and avoid a larger size.

Another aspect of the invention is characterized by further having a platform on which the film is placed during cutting, wherein a protective unit comprising a material that does not absorb lasers is provided in the location where the laser is directed onto the film on the platform.

In the above aspect, the location irradiated by the laser is protected by the protective unit, thus preventing the platform from deteriorating. The platform is also prevented from smoking.

Another aspect is characterized in that the suction unit has a first air intake unit provided at a position, on the film, corresponding to the outer edge of the substrate, and a second air intake unit provided on the film inside the inner edge of the substrate.

In the above aspect, the first air intake unit suctions from outside the outer edge, and the second air intake unit suctions from inside the inner edge, thus preventing smoke from flowing onto the surface of the film corresponding to the substrate.

Another aspect of the invention is characterized in that the first air intake unit is provided with an air flow buffer space.

In the above aspect, the flow of air is stabilized by flowing through the buffer space when suctioned from the first air intake unit.

Another aspect of the invention is characterized in that a plurality of first air intake units are provided so that smoke is vortically suctioned off.

In the above aspect, smoke is vortically suctioned off, ensuring that smoke is prevented from flowing onto the film surface.

Another aspect of the invention is characterized in that the second air intake unit has a cut film discharging path.

In the above aspect, cut film can be exhausted at the same time that smoke is suctioned off by the second air intake unit, thus making it unnecessary to prepare any special device for exhaust.

Another aspect of the invention is characterized in that the second air intake unit has an air intake tube penetrating the incision.

Another aspect of the invention is characterized in that the adjusting unit comprises a cover unit covering the location where the film is irradiated with the laser, and has an exhaust unit for exhausting the air inside the cover unit.

In the above aspect, air can be exhausted from the space covered by the cover unit to reduce the smoke that is produced.

Another aspect of the invention is characterized in that at least part of the cover unit is formed of a laser-permeable material.

The above aspect allows laser irradiation from outside the cover unit, thus allowing the cover to be made smaller and the level of exhaust to be lowered to shorten the takt time.

As described above, the present invention can provide a film cutting device and film cutting method in which smoke that is produced while a protective film is being cut by a laser along the outer and inner edges of a substrate can be efficiently exhausted while the smoke is prevented from adhering to the film.

### BRIEF DESCRIPTION OF THE DRAWINGS

FIG. 1 is a cross sectional view showing the Outer edge being cut in an embodiment of the film cutting device of the present invention;

FIG. 2 is a plan of FIG. 1;

FIG. 3 is a cross sectional view showing the incision being made in the embodiment of FIG. 1;

FIG. 4 is a plan of FIG. 3;

FIG. 5 is a cross sectional view showing the inner edge being cut in the embodiment in FIG. 1;

FIG. 6 is a plan of FIG. 5;

FIG. 7 is a cross sectional view showing the outer edge being cut in an embodiment in which the adjusting unit and air intake units are separate in the film cutting device of the invention;

FIG. 8 is a plan of FIG. 7;

FIG. 9 is a cross sectional view showing the inner edge being cut in the embodiment in FIG. 7;

FIG. 10 is a cross sectional view showing the exhaust structure of the cutting unit in an embodiment of the film cutting device of the invention;

FIG. 11 is a cross sectional view showing the film vacuum chuck structure in an embodiment of the film cutting device of the invention;

FIG. 12 is a cross sectional view showing the exhaust structure of the cutting unit and the cutting location of the inner edge in an embodiment of the film cutting device of the invention;

FIG. 13 is a cross sectional view showing the exhaust state of the cutting unit in FIG. 12;

FIG. 14 is a cross sectional view showing an example in which the inner air intake unit is in the form of a tubular body through the film in an embodiment of the film cutting device of the invention;

FIG. 15 is a cross sectional view showing an example in which the vacuum chuck and support rings are combined with a table in an embodiment of the film cutting device of the invention;

FIG. 16 is a plan of the table in FIG. 15;

FIG. 17 is a perspective detail showing the relationship between the support rings and grooves in FIG. 15;

FIG. 18 is a cross sectional view showing an embodiment in which film is cut by laser radiation inside the cover of the film cutting device of the invention;

FIG. 19 is a cross sectional view showing an embodiment in which film is cut by laser radiation from outside the cover of the film cutting device of the invention;

FIG. 20 is a cross sectional view showing a cover with divided cutting spaces in an embodiment of the film cutting device in the invention;

FIG. 21 is a cross sectional view showing an embodiment in which the air intake units and adjusting unit can be moved as a single unit in the film cutting device of the invention;

FIG. 22 is a plan showing an embodiment in which the air intake units and adjusting unit can be moved as a single unit and are separate on the inside and outside in the film cutting device of the invention;

FIG. 23 is a plan showing an embodiment in which the air intake unit and adjusting unit are a single unit and can be moved as the laser is operated; and

FIG. 24 is a cross sectional view showing (a) a unit being moved alongside of the cut line in FIG. 23 and (b) a unit being moved above the line.

### EXPLANATION OF REFERENCE NUMERALS

### Best Mode for Carrying Out the Invention

Preferred embodiments (referred to below as embodiments) of the present invention are described in detail below with reference to the attached drawings.

(Structure)

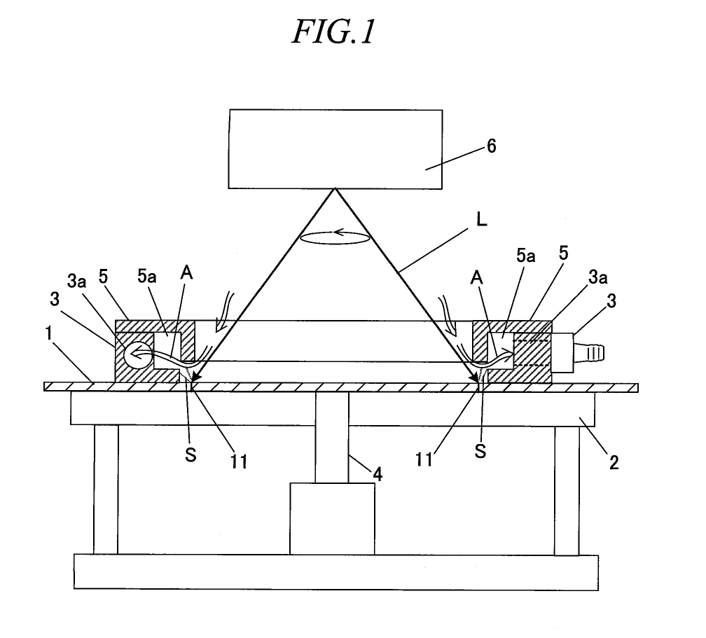

The structure of the present embodiment (referred to below as device) will first be described below with reference to FIGS. 1 through 5. The device is a film cutting device for cutting protective sheets for optical disks from film 1, wherein the reel device for feeding and winding the film 1, the handling device for handling and conveying the cut sheet, and the like will not be elaborated as any well known technique can be applied.

That is, the device is equipped, as shown in FIG. 1, a table 2, first air intake units 3, second air intake unit 4, adjusting units 5, laser radiation device 6, and the like. The table 2 is a platform over which the conveyed film 1 passes while horizontally supported under a constant tension. The film 1 is repeatedly moved long enough to ensure that there is enough film to cut out and alternately stopped long enough for the film to be cut.

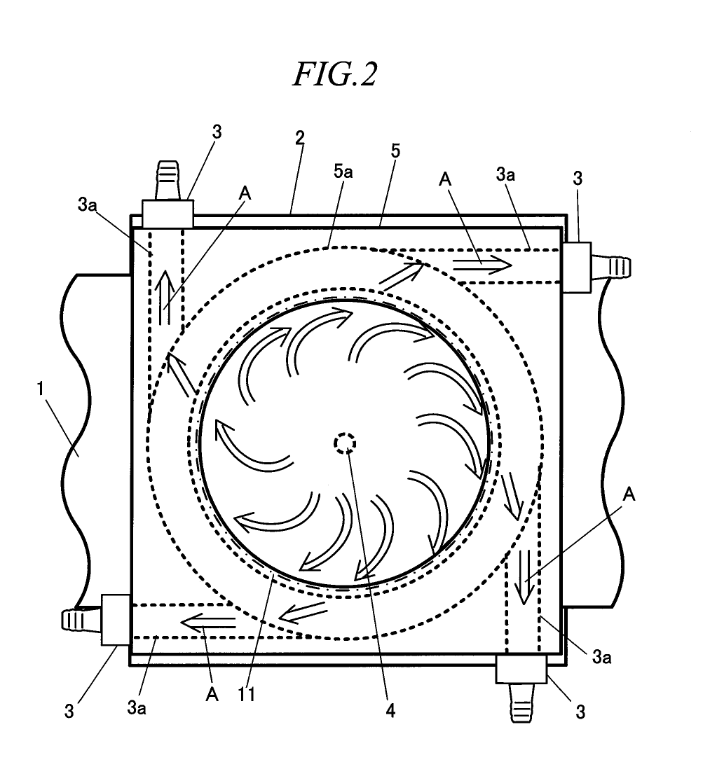

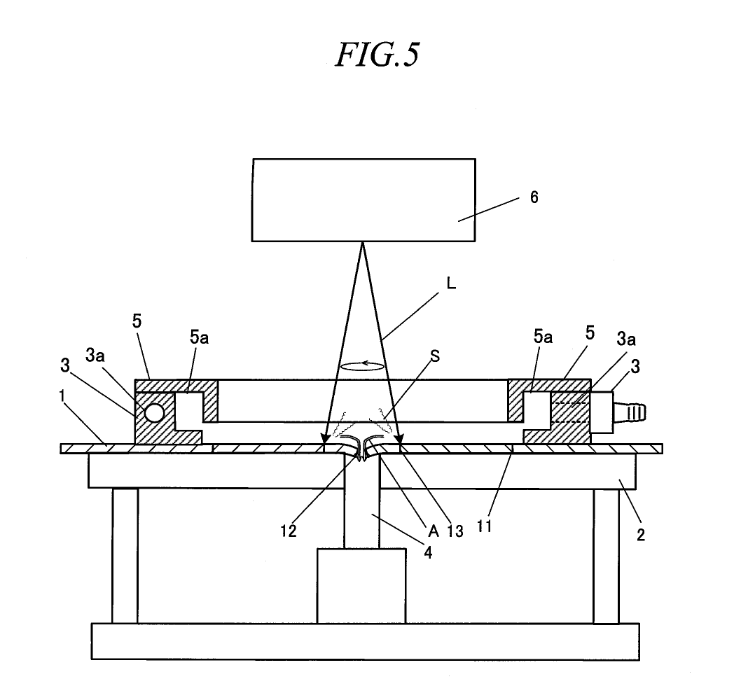

Four first air intake units 3 are connected to an air source (not shown) and are arranged outside a line 11 on the film 1 corresponding to the outer edge of the disk. As shown in FIG. 2, the first air intake units 3 have holes 3a formed in directions generally intersecting each other so that the air flow A is produced in the form of a vortex (cyclone) toward the outside of the outer edge. The second air intake unit 4 is an end opening in the flow path connected to the air source (not shown), and is located underneath the inside of a line 13 (see FIG. 5) on the film 1 corresponding to the inner edge of the disk.

The adjusting units 5 are means for adjusting the air flow produced by the first air intake units 3, and are arranged above the film 1 passing over the table 2. The adjusting units 5 have a tubular section that prevents the smoke that has been suctioned out from flowing back in, and is provided high enough to form a space for the air flow to pass through between the floor and film 1. An air flow buffer space 5a is provided between the air adjusting unit 5 and first air intake unit 3.

The floor of the first air intake unit 3 floats slightly off the film 1. However, the first air intake units 3 and adjusting units 5 may be elevatably formed to drop down when the film is being cut, so as to come into contact with the film 1 and press the film 1 to keep the film 1 in place. The portion where the tubular section of the adjusting unit 5 and the first air intake unit 3 are in contact is separably provided to make it easier to clean the inner surface of the buffer space 5a.

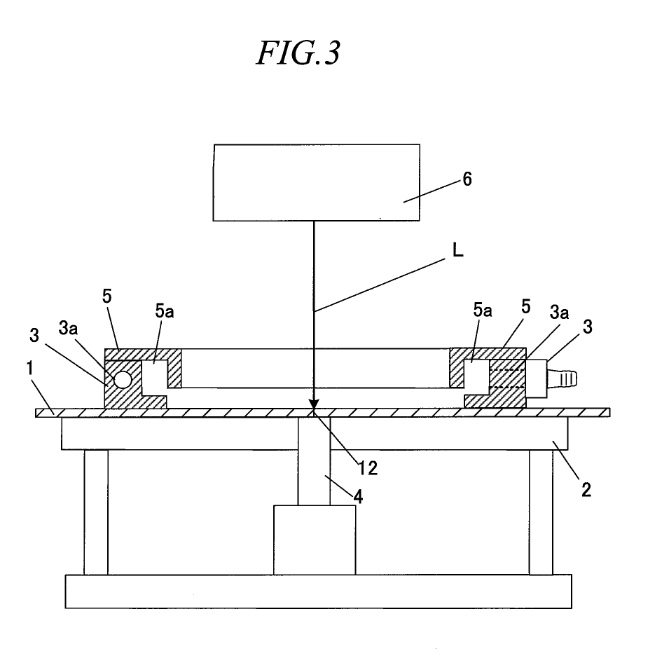

The laser radiating device 6 is the device for cutting the film 1 with a CO₂ laser, the power of which can be controlled in conformity with the thickness of the film 1. In this embodiment, the laser L radiation direction and location can be changed to cut the round line 11 on the film 1 corresponding to the outer edge of the disk and the round line 13 corresponding to the inner edge, and to make an incision 12 (FIG. 3) inside the circle corresponding to the inner edge.

The vacuum source for the first air intake units 3 and second air intake unit 4 may be a shared source or independent sources, but the intake timing of the first air intake units 3, the timing of the second air intake unit 4, and the timing of the laser L radiation of the laser radiation device 6 are controlled as will be described below by a control device (not shown). The invention also includes programs for running such a control device with a computer as well as recording media on which the program is recorded.

(Operation)

A method for cutting film 1 with the device such as the above will be described with reference to FIGS. 1 through 6. First, as shown in FIG. 1, the vacuum source is activated to produce an air flow A to the first air intake units 3, and the laser radiation device 6 is used to direct the laser L onto the round line 11 on the film 1 along the outer edge of the disk.

The air flow A through the buffer spaces 5a is stabilized, and then passes through the holes 3a out of the first air intake units 3. Smoke S produced at the cutting location at that time is exhausted by the air flow A. As shown in FIG. 2, the air flow A is produced in the form of a vortex toward the outside of the outer edge, and the inside and outside of the outer edge are divided by the tubular section of the adjusting units 5, thus preventing the smoke S from flowing into the surface of the film 1 corresponding to the disk.

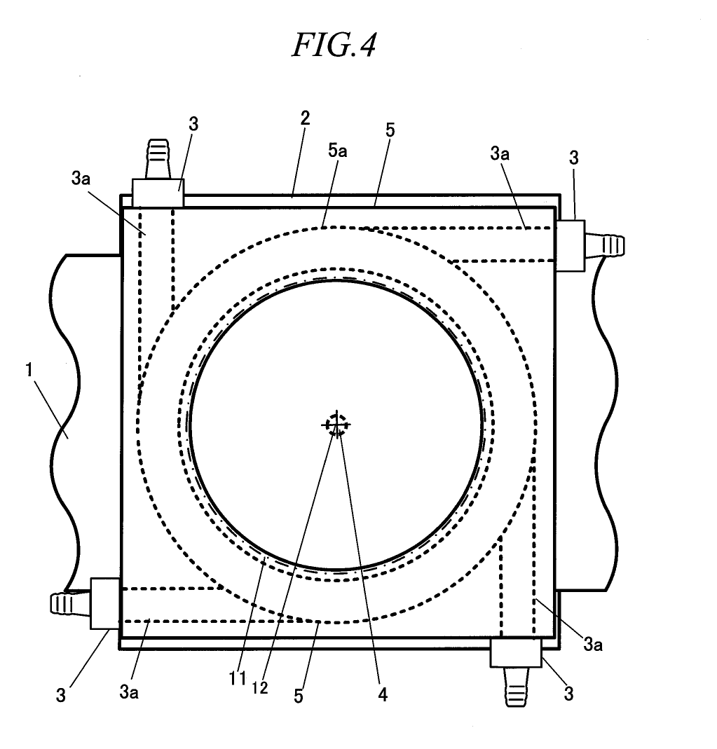

The intake of the first air intake units 3 is then stopped, and the vacuum source is activated to start the air intake of the second air intake unit 4. As shown in FIGS. 3 and 4, the laser radiation device 6 is then used to direct the laser L onto the film 1 inside of the inner edge to make an incision 12. The incision 12 is in the form of a cross in the example given in FIG. 4, but is not necessarily limited to this shape. The air intake of the second air intake unit 4 may also be simultaneous with the incision by the laser L.

The incision 12 is made in this manner so as to produce an air flow A to the second air intake unit 4 as shown in FIG. 5. Under these conditions, by the laser radiation device 6 the laser L is directed onto the round line 13 on the film 1 along the inner edge of the disk. Smoke S produced at the cut is suctioned off into the second air intake unit 4 by the air flow A.

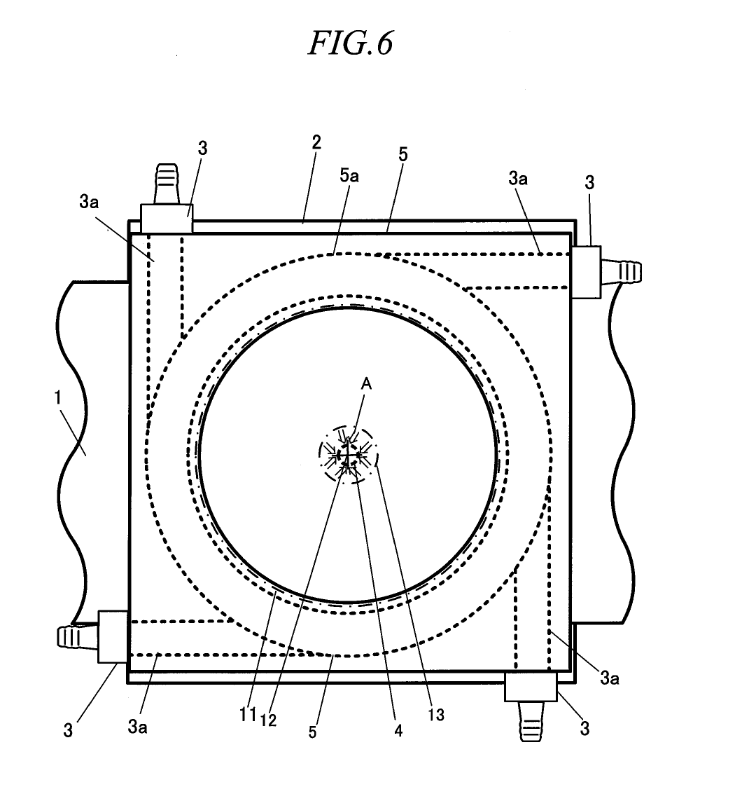

As shown in FIG. 6, the air flow A is produced toward the incision on the inside of the inner edge of the disk, thus preventing the smoke S from flowing onto the surface of the film 1 corresponding to the disk. The intake of the second air intake unit 4 is then stopped. The sheet cut out from the film 1 as noted above is conveyed out by the handling device to be processed in a subsequent step. The portion cut out from the inside may be removed by the same or another handling device, and may be removed by the intake of the second air intake unit 4.

(Effect)

According to the above embodiment, the film can be cut without contact by the laser L, thus resulting in a smoothly finished cut without producing burrs or chips. The smoke S produced when the film is being cut is removed by the first air intake unit 3 and the second air intake unit 4, thus preventing contamination by the smoke S.

Also, when the film is being cut on the line 11 corresponding to the outer edge of the disk, the first air intake units 3 take in air to the outside, and the smoke S is prevented from flowing back inside by the adjusting units 5. When the film is being cut along line 13 corresponding to the inner edge of the disk, the second air intake unit 4 takes in air to the inside. Smoke S therefore will not flow through and adhere to the surface of the film 1 corresponding to the disk. In particular, the air flow produced by the intake of the first air intake units 3, as noted above, is in the form of a vortex toward the outside, thus preventing smoke produced on the opposite facing side from being suctioned and passing through the face of the film 1.

When the line 13 of the inner edge is being cut, an incision 12 is made to cut the line 13 while the film 1 is suctioned from below by the second air intake unit 4, thus preventing the film 1 from floating. Furthermore, the intake of the second air intake unit 4 is started before or as the incision 12 is made, thus allowing smoke S that is produced by the incision to be immediately exhausted off.

### OTHER EMBODIMENTS

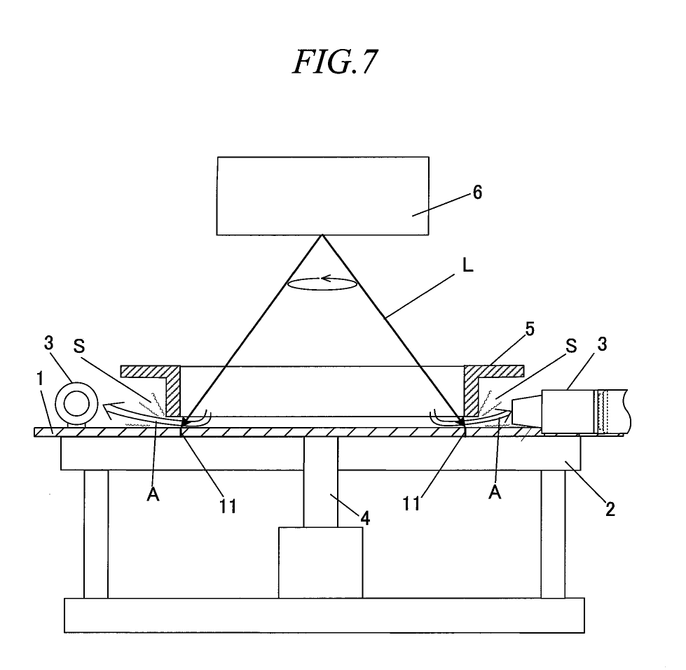

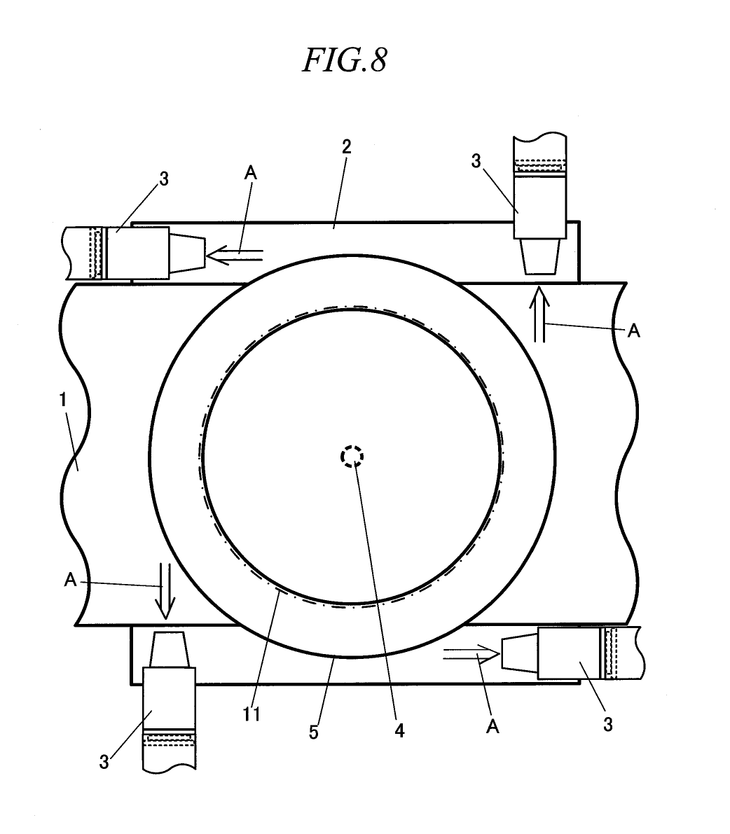

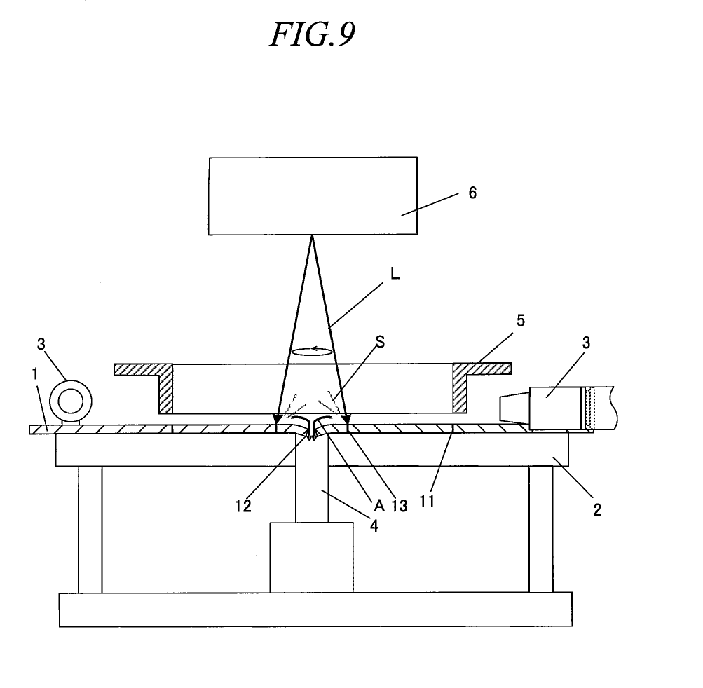

The invention is not limited to the above embodiment. As shown in FIGS. 7 through 9, for example, the first air intake units 3 may be formed independently of the adjusting units 5. In that case, the operating procedures will be the same as the above embodiment.

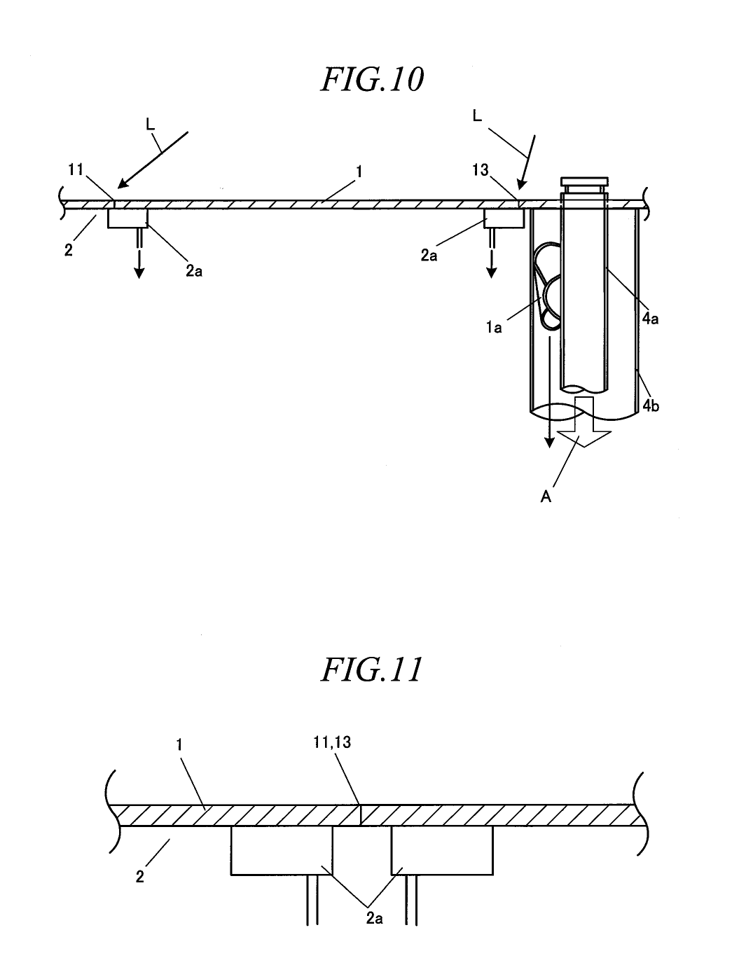

As mentioned in the above embodiment, the part where the incision is made on the inside of the film 1 may be removed by the air intake of the second air intake unit 4, thereby eliminating the need for a device to remove the part where the incision is made. As a structure that may be contemplated for that purpose, the second air intake unit 4 may be made in the form of a double structure comprising an inner tube 4a and outer tube 4b, as shown in FIG. 10, for example, wherein the smoke S is exhausted off through the inner tube 4a and the part 1a where the incision has been made is removed and recovered through the outer tube 4b.

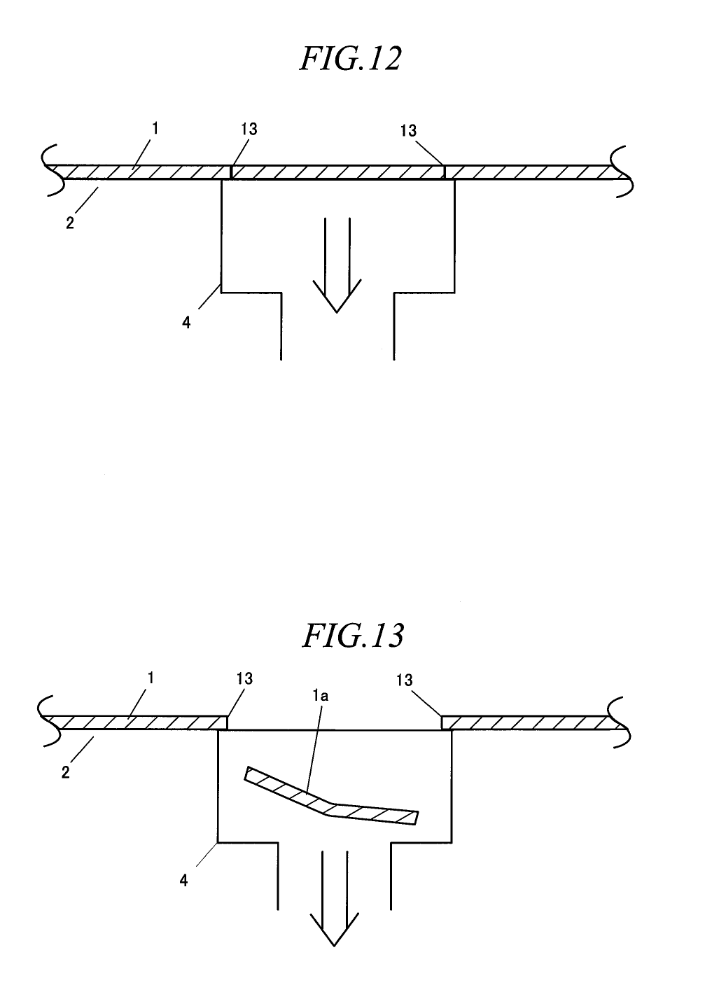

In this case, in order to allow the portion 1a where the incision has been made and the film 1 to be well separated, the table 2 may be provided with grooves 2a that communicate with the vacuum source to create a vacuum chuck for the film 1. As shown in FIG. 11, the location of the grooves 2a need not necessarily be aligned with the lines 11 and 13 which are to be cut. As also shown in FIGS. 12 and 13, the line 13 that is to be cut may be on the inside of the upper opening in the second air intake unit 4. This will allow the portion 1a where the incision has been made to be smoothly removed.

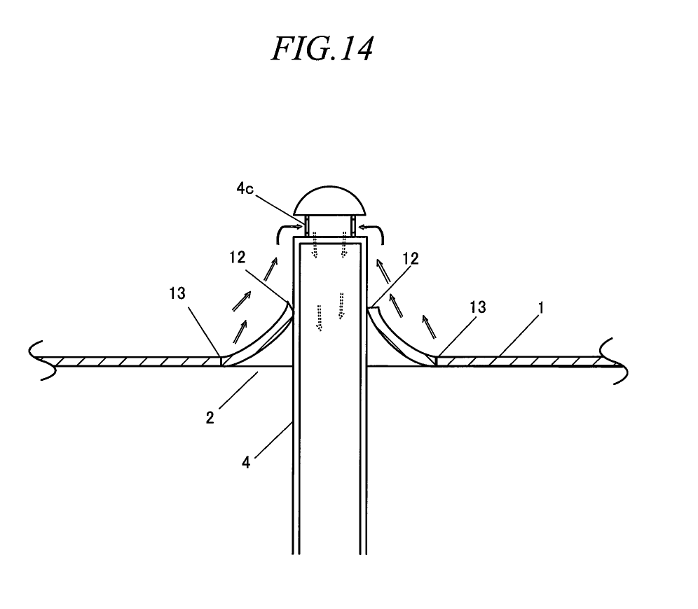

Though shown in the example of FIG. 10, the second air intake unit 4 may also be in the form of a tubular element, as shown in FIG. 14, which protrudes so as to penetrate the film 1 and allows the smoke S to be suctioned off through a hole 4c in the periphery. The movably provided second air intake unit 4 tip may be sharp so as to be lifted in order to penetrate the film 1 and simultaneously make an incision 12.

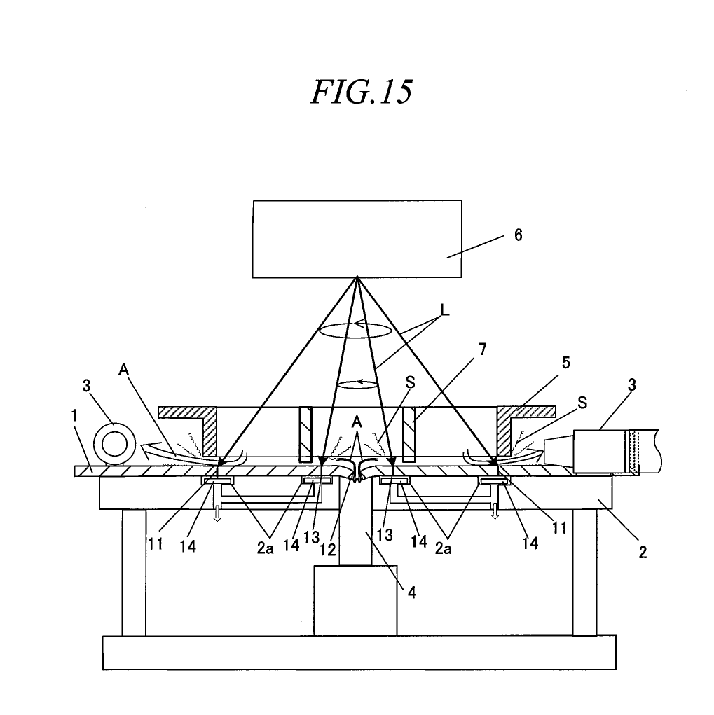

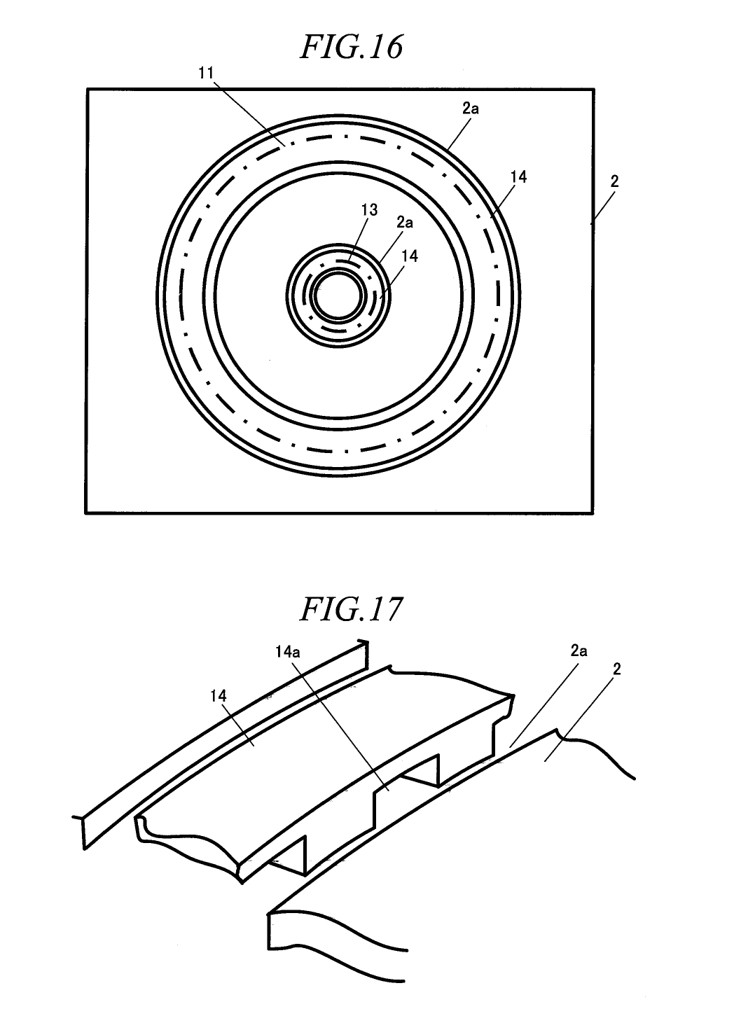

Additionally, as shown in FIGS. 15 through 17, the grooves 2a used as a vacuum chuck to keep the film 1 on the table 2 may be formed in the shape of rings in locations corresponding to the outer line 11 and dinner line 13, and support rings 14 may be provided in the grooves 2a. The support rings 14 are formed or coated with a material that does not absorb the laser L (such as polytetrafluoroethylene (PTFE)). The top of the support ring 14 is a flat surface nearly the same level as the table 2, and a groove 14a through which air can flow is formed in the bottom (see FIG. 17).

Creating such a structure will allow a vacuum chuck to be produced through the grooves 2a and keep the lines 11 and 13 from deviating when the film is irradiated with the laser L. Furthermore, the locations irradiated by the laser L are supported by support rings 14 made of a material that will not absorb the laser L, thus preventing deterioration and smoke caused by the laser L. The support rings 14 will be slightly damaged by the laser L, but only the support rings 14 will be replaced after prolonged use, thus making it unnecessary to replace or repair the entire table 2. In any of the above embodiments, the table 2 itself may be formed or coated with a material that will not absorb the laser L to prevent deterioration or smoke.

Also, in this example, a partition 7 is provided to prevent smoke S produced on the outside from moving inward and smoke S produced on the inside from moving outward. Smoke S can thus be prevented from flowing onto the surface of the film 1 when the outer line 11 and inner line 13 are simultaneously cut.

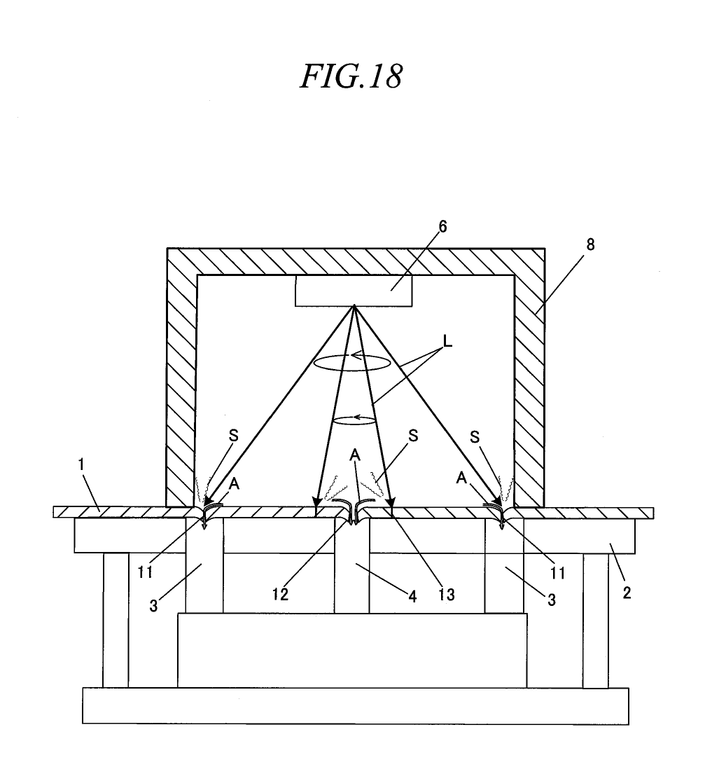

As the adjusting unit shown in FIG. 18, a cover 8 covering the entire cutting region on the film 1 is elevatably provided, allowing the film to be cut with the laser L as the outer line 11 and inner line 13 are suctioned from below by the first air intake units 3 and the second air intake unit (doubling as the second air intake unit and exhaust unit in the claims) while the top of the film 1 is closely sealed off by the cover 8.

Smoke may be produced through the presence of oxygen, but the film will be cut in nearly a vacuum state in the case illustrated in FIG. 18, thus removing smoke S will suppressing preventing smoke S itself from being produced. The vacuum source may also be connected to the cover 8 to exhaust the interior of the cover 8 and thereby help exhaust air. The partition 7 illustrated in FIG. 17 may also be provided.

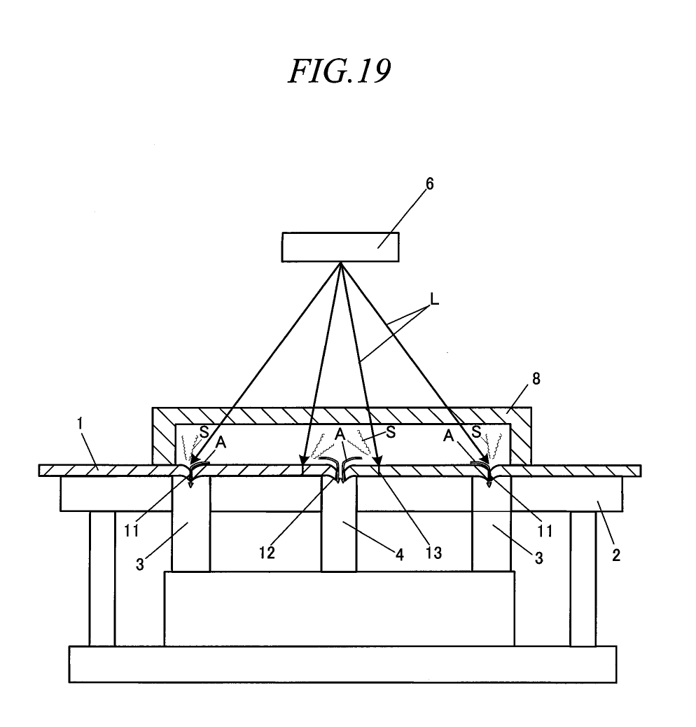

As also illustrated in FIG. 19, part or all of the cover 8 may be formed with a laser-permeable material, and the laser radiation device 6 may be located outside the cover 8 to allow the film to be irradiated by the laser L from outside the cover 8. This can reduce the volume inside the cover 8 and reduce the exhaust level, thereby shortening the tact time.

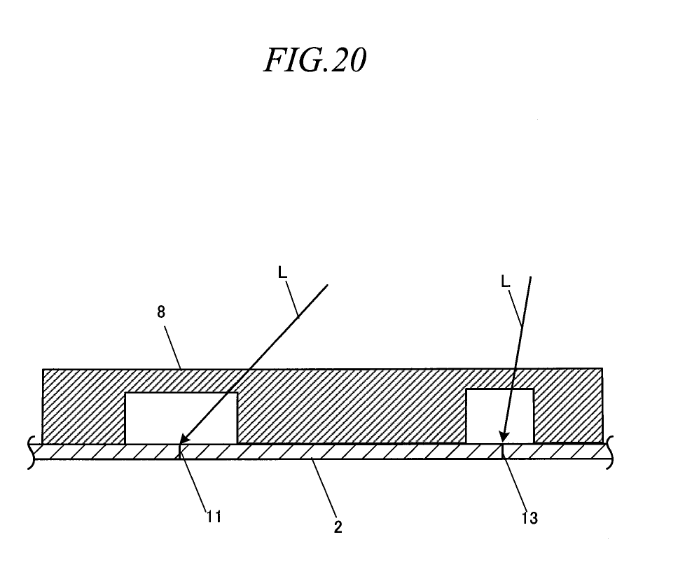

As also shown in FIG. 20, the region inside the cover 8 may be divided by the inner line 11 and outer line 13 to shut out any path for smoke S between the inside and outside. In the examples of FIGS. 18 through 20, purge with an inert gas (such as N₂) may be performed to the cutting unit as it is intended to exhaust any air therein. In this case as well, lower amounts of inert gas for purging can be used the smaller the cover 8. The positions may be provided above or below the cover 8 to supply the inert gas for purging and exhaust off the air.

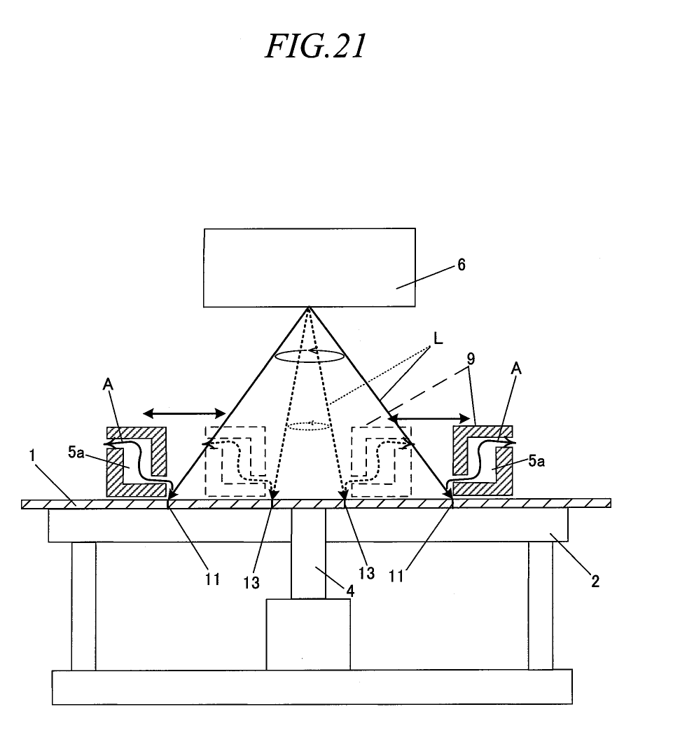

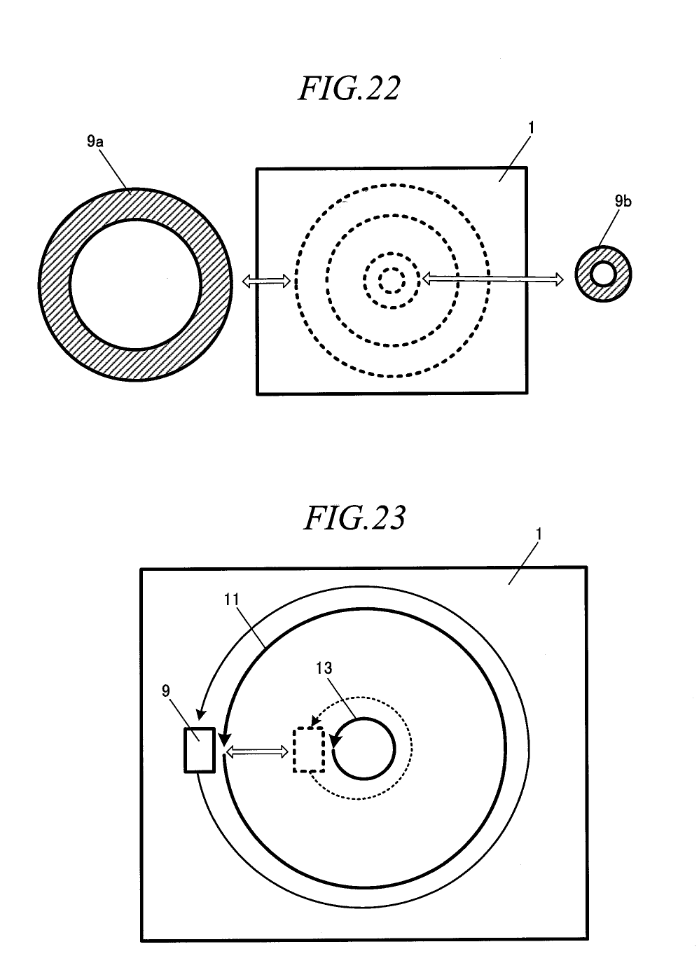

As also illustrated in FIG. 21, a unit 9 comprising a unified intake unit and adjusting unit may be movably constructed between the outside and inside, so that both the outer line 11 and inner line 13 can be exhausted by the same unit 9 when the film is being cut. As furthermore shown in FIG. 22, an outer unit 9a and inner unit 9b may be separately provided and may be moved so as to alternately change places, thereby sequentially cutting the outer line 11 and inner line 13.

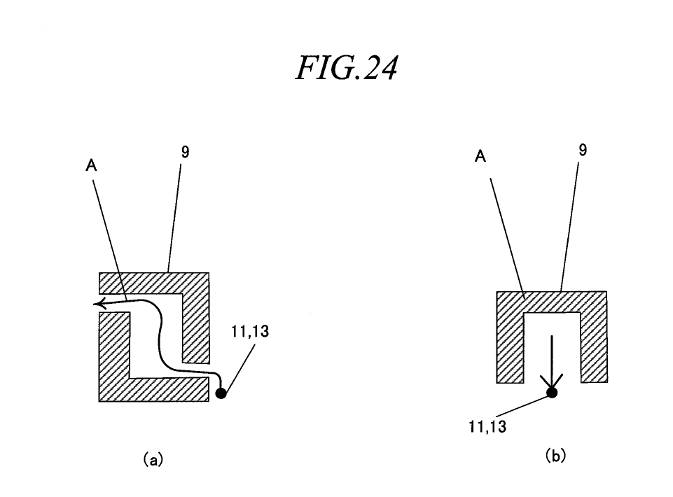

As also illustrated in FIG. 23, the unit 9 may be made smaller and moved with the operation of the laser L. In this case, the unit 9 may be constructed so as to be moved between the outside and inside, and separate units 9 may also be provided separately on the outside and inside. As shown in FIG. 24(a), the small unit 9 may be located so as to be moved immediately beside the lines 11 and 13, and as shown in FIG. 24(b), may be moved over the lines 11 and 13. When moved over the lines 11 and 13, part or all of the unit 9 may be formed with a laser L-permeable material.

Separate laser radiation devices may be provided to cut the outer line 11 and inner line 13. The incision device for making an incision is not limited to the laser radiation device. Anything such as a blade, needle, pin, or tube may be used if the incision (including holes) is to be made by a sharp tip. As noted above, a tube may be movable so as to make an incision by means of the tip of an air intake tube.

The number of air intake units is also not limited to those given as examples in the above embodiments. It is desirable to prevent the suctioning of smoke on the opposite side if the direction of the air flow produced by the intake of the air intake units is in the form of a vortex, as noted above, but the direction is not limited to this. A radial air flow may also be used, for example.

The film material is also generally a polycarbonate (PC) or the like, and is not limited to specific types. Disks suitable for the present invention may be in a variety of sizes, shapes, materials, and the like, making the invention suitable for any that may be used in the future. Furthermore, the film used in the invention is not limited to those for disks as recording media and is suitable for any films used for recording media disks and any substrates requiring outer and inner edges to be cut in the manufacturing process.

In other words, “substrate” as set forth in the claims is a concept broadly encompassing flat products, not just disks or the like. Accordingly, laser tracking is not limited to circles, provided that the inner and outer edges of a substrate are followed.

1. A film cutting device, comprising:
a cutting unit for cutting film along outer and inner edges of a substrate by laser radiation;
a suction unit for suctioning smoke produced when the film is cut by the cutting unit; and
an adjusting unit for adjusting an air flow of the suction device to control the flow of smoke onto the film surface that corresponds to the substrate.

2. The film cutting device according to claim 1, further comprising an incision unit for forming an incision on the inside of a corresponding position on the film to the inner edge of the substrate before or when a film is cut along the inner edge of the substrate by the cutting device.

3. The film cutting device according to claim 2, wherein the cutting unit and the incision unit serve as a laser radiation device.

4. The film cutting device according to claim 1, further comprising a platform on which the film is placed during cutting, wherein
a protective unit comprising a material that does not absorb lasers is provided in the location where the laser is directed onto the film on the platform.

5. The film cutting device according to claim 1, wherein the suction unit has a first air intake unit provided at a position, on the film, corresponding to the outer edge of the substrate, and a second air intake unit provided on the film inside the inner edge of the substrate.

6. The film cutting device according to claim 5, wherein the first air intake unit is provided with an air flow buffer space.

7. The film cutting device according to claim 5, wherein a plurality of the first air intake units are provided so that smoke is vortically suctioned off.

8. The film cutting device according to claim 5,
wherein the second air intake unit has a cut film discharging path.

9. The film cutting device according to claim 5, wherein the second air intake unit has an air intake tube penetrating the incision.

10. The film cutting device according to claim 1, wherein
the adjusting unit comprises a cover unit covering the location where the film is irradiated with the laser, and has an exhaust unit for exhausting the air inside the cover unit.

11. The film cutting device according to claim 10, wherein at least part of the cover unit is formed of a laser-permeable material.

12. A film cutting method, comprising:
cutting a film along the outer edge of a substrate by laser radiation, and allowing smoke produced during the cutting to be suctioned off in the outward direction toward the outer edge of the substrate in the film;
forming an incision in the film on the inside of the inner edge of the substrate using laser radiation or a cutter; and
cutting the film along the inner edge of the substrate and allowing the smoke, produced during the film cutting, to be suctioned off in the inward direction toward the inner edge of the substrate in the film.
